(19) United States
(12) Patent Application Publication
(10) Pub. No.: US 2025/0323673 A1
(43) Pub. Date: Oct. 16, 2025

(54) SYSTEM AND METHOD FOR LINEARIZATION OF A POWER AMPLIFIER CHAIN

(71) Applicant: Tejas Networks Limited, Bangalore (IN)

(72) Inventors: Girish Chandra TRIPATHI, Uttar Pradesh (IN); Ratnesh Kumar GAUR, Bangalore (IN); Anindya SAHA, Bangalore (IN); Ramesh S, Bangalore (IN)

(73) Assignee: Tejas Networks Limited, Bangalore (IN)

(21) Appl. No.: 19/042,382

(22) Filed: Jan. 31, 2025

(30) Foreign Application Priority Data
Apr. 10, 2024 (IN) 202441029203

(51) Int. Cl. H04B 1/04

(52) U.S. Cl. CPC H04B 1/0475; H04B 2001/0408

(57) ABSTRACT

The present disclosure provides a system and a method for linearization of a power amplifier chain. The system determines a predistorted signal associated with a coupled power output of a power amplifier along a first transmission path among one or more transmission paths based on a RF input signal received by the transceiver. The system determines, an output signal associated with the coupled power output of the PA along a second transmission path among the one or more transmission paths, where the coupled power output is based on the predistorted signal. The system monitors, the output signal associated with the PA. The system varies the predistorted signal to generate the power output through the PA.

### CROSS-REFERENCE TO RELATED APPLICATION

This application is based upon and claims the benefit of priority from Indian Patent Application number 202441029203, filed Apr. 10, 2024, the entire contents of which are incorporated herein by reference.

### FIELD OF INVENTION

The embodiments of the present disclosure generally relate to a field of fourth generation (4G) and fifth generation (5G) wireless networks. More particularly, the present disclosure relates to a system and a method for linearization of a power amplifier chain.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Conventionally, a pre-driver and driver chain (PDDC) preceding a power amplifier is used to provide an improved overall efficiency and linearity of a transmitter of a base station. Typically, PDDC is operated in a linear region but that does not provide significant power saving. If the PDDC is driven into mild/high non-linearity for improved efficiency, then the PDDC output, when applied to the power amplifier will result in increased output distortion. However, a linear (distortion-less) input to the power amplifier may result in reduced power efficiency of the PDDC.

Prior art described in “Sequential Digital Predistortion for Two-stage Envelope Tracking Power Amplifier,” in IEEE Microwave and Wireless Components Letters, vol. 23, no. 11, pp. 620-622, November 2013 discloses observation paths for linearizing a single transmitter, while increasing the hardware cost. The system utilizes digital pre-distortion (DPD), however if external conditions change or there is less traffic, the DPD performance may vary as the system does not monitor the driver power amplifier.

Prior art described in “An Improved Doherty Amplifier Using Cascaded Digital Predistortion and Digital Gate Voltage Enhancement,” in IEEE Transactions on Microwave Theory and Techniques, vol. 57, no. 12, pp. 3118-3126 December 2009, discloses a memory and memoryless approach for a main power amplifier linearization and without consideration the performance of a driver power amplifier. The presented method is tested on a 20 MHz signal where upon an increase in a signal bandwidth, the performance of the model is degraded since the memoryless Look-Up Table (LUT) cannot model higher bandwidth (BW) signals. Further, a continuous gate voltage modification with DPD adds more complexity while requiring extra hardware and power consumption. Furthermore, the memory-less LUT does not account for input power changes, hence linearization performance associated with the main power amplifier is degraded.

Prior art U.S. Pat. No. 9,031,521B2 discloses a method for operating a power amplifier where the method includes performing a training phase and operating phase associated with the power amplifier. The training phase includes establishing pre-computed distortion contributions based on pre-compensation training feedback signals representative of output of the power amplifier. Further, the training phase includes storing the pre-computed distortion contributions in a lookup table. The operating phase includes switching a controller off to disconnect signal representative of the output of the power amplifier and accepting an original value that reflects information to be communicated. The operating phase includes generating a digital lookup table key based on the original value and retrieving from the lookup table, using the digital lookup table key, a corresponding pre-computed distortion contribution for the original value. Further, the operating phase includes distorting the original value based on the corresponding pre-computed distortion contribution to obtain a distorted value to pre-compensate for the nonlinear characteristics of the power amplifier. Furthermore, the operating phase includes wirelessly transmitting a pre-distorted signal based on the distorted value. However, the method does not include DPD associated with a pre-driver/driver prior to the amplification of an input signal.

Prior art CN113162559B discloses a system where a millimetre wave frequency band radio frequency signal enters the analog predistortion linearizer after being preamplified by the front-stage drive amplifier from an input port. The millimetre wave frequency band radio frequency signal is subjected to predistortion on the radio frequency signal, enters the gain adjustable amplifier to amplify the signal, outputs a main signal of an amplified final-stage power amplifier input signal to the final-stage power amplifier, and outputs a final-stage output signal after being amplified by the power amplifier. Parts of the signal of the final-stage power amplifier are coupled through a coupler at the input end of the final-stage power amplifier where the part of signals enter a power division detection branch of a non-linear parameter extraction circuit of the final-stage power amplifier. However, the system discloses an analogue pre distorter (APD) scheme for millimetre wave radio applications.

Prior art KR20000009734U discloses linearization of a main power amplifier by generating an artificial IMD component to attenuate the IMD component generated in the main amplifier. Hence, this method is a feed-forward mechanism to pre-distort the signal, where the feed forward linearization includes receiving the output of the main power amplifier in which the IMD component is firstly attenuated by the pre-distorted signal to attenuate the IMD component secondarily. However, the method does not describe DPD of an amplifier chain in a transceiver.

Prior art KR20080065042 discloses a digital predistortion linearizer for a Doherty power amplifier. The system includes a pre-compensator for compensating and outputting the predistortion of the input signal for each class according to the class of the amplifier included in the amplifier. Further, a method is included for converting the output of the pre-compensator into an analog signal of intermediate frequency and converting each analog signal in each class of the amplifier into a high frequency signal, and outputting the high frequency signal to the amplifier for each class of the amplifier. However, the system is specific to the Doherty Amplifier and works in an arrangement where an auxiliary amplifier is also required for linearization.

Prior art US00580851 discloses a system with a linear power amplifier that uses active feedback pre-distortion linearization. The linear power amplifier is implemented as a two-stage amplifier with pre-distortion active feedback, a driver amplifier, and a power amplifier. The system uses analog linearization specifically for bipolar power transistors. However, the present disclosure may be implemented with any driver and power amplifier.

Prior art US009020454 discloses an apparatus and a method for dynamic adjustment of the drain or a collector voltage of a power amplifier, including a power amplifier having a voltage input, a temperature sensor measuring the ambient temperature of the power amplifier, and an adaptive power amplifier control processor that dynamically changes the input voltage based on the ambient temperature. The apparatus achieves the desired peak power when the system is subjected to high temperatures. However, present disclosure uses DPD for improving power efficiency of the power amplifier.

Prior art US20220140479 discloses switchable feedback paths that can selectively feedback a transmitted radio frequency (RF) signal for the purpose of calibration in a phased array transceiver. However, the present disclosure uses DPD for improving power efficiency of the power amplifier.

There is, therefore, a need in the art to provide an improved system and a method that can mitigate the deficiencies of the prior art(s).

### OBJECTS OF THE INVENTION

Some of the objects of the present disclosure, which at least one embodiment herein satisfies are listed herein below.

It is an object of the present disclosure to provide a system and a method that linearizes a power output of a power amplifier (PA) for improving the power efficiency of the PA.

It is an object of the present disclosure to provide a system and a method that uses cascaded drivers prefixed to the PA to facilitate the linearized power output from the PA.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a method for generating a power output in a transceiver. The method includes determining, a predistorted signal associated with a coupled power output of a power amplifier (PA) along a first transmission path among one or more transmission paths based on a received RF input signal. The method includes determining, an output signal associated with the coupled power output of the power amplifier (PA) along a second transmission path among the one or more transmission paths, where the coupled power output is based on the predistorted signal. The method includes monitoring, the output signal associated with the PA. The method includes varying the predistorted signal to generate the power output through the PA.

In an embodiment, the PA includes one or more cascaded drivers prefixed with the PA that generates the predistorted signal.

In an embodiment, the method may include computing, one or more inverse co-efficients associated with a gain of the PA, where the gain may be computed based on the output signal associated with the PA.

In an embodiment, the method may include recording, the one or more inverse co-efficients associated with the gain in a Look-Up Table (LUT).

In an embodiment, the method may include computing, an error based on a difference between the gain of the PA and the RF input signal and facilitating the modification of the predistorted signal.

In an embodiment, the method may include computing, one or more inverse co-efficients of the one or more cascaded drivers to determine a gain of the one or more cascaded drivers along the first transmission path for generating the predistorted signal.

In an embodiment, the method may include recording, the one or more inverse co-efficients of the one or more cascaded drivers in the LUT.

In an embodiment, the method may include facilitating, the measurement of the predistorted signal of the one or more cascaded drivers.

In an embodiment, the method may include facilitating, the measurement of the output signal of the PA along the second transmission path.

In an embodiment, the method may include continuously monitoring, an error based on a difference between the output signal of the PA and the RF input signal and re-computing, the gain of the one or more cascaded drivers based on the error.

In an embodiment, the method may include modifying, the predistorted signal based on the re-computed gain of the one or more cascaded drivers and providing the modified predistorted signal to the PA.

In an aspect, the present disclosure relates to a system for generating a power output in a transceiver system. The system includes a processor communicatively coupled to a transceiver of the system. A memory is operatively coupled with the processor, where said memory stores instructions which, when executed by the processor, cause the processor to determine a predistorted signal associated with a coupled power output of a PA along a first transmission path among one or more transmission paths based on an RF input signal received by the transceiver. The processor determines, an output signal associated with the coupled power output of the PA along a second transmission path among the one or more transmission paths. The coupled power output is based on the predistorted signal. The processor monitors, the output signal associated with the PA. The processor varies the predistorted signal to generate the power output through the PA.

In an embodiment, the PA includes one or more cascaded drivers prefixed with the PA that generates the predistorted signal.

In an embodiment, the processor may be configured to compute, one or more inverse co-efficients associated with a gain of the PA, where the gain is computed by the processor (202) based on the output signal associated with the PA.

In an embodiment, the processor may be configured to record the one or more inverse co-efficients associated with the gain in an LUT of the memory.

In an embodiment, the processor may be configured to compute an error based on a difference between the gain of the PA and the RF input signal using a Digital Pre-Distortion (DPD) technique and facilitate the modification of the predistorted signal.

In an embodiment, the processor may be configured to compute one or more inverse co-efficients of the one or more cascaded drivers to determine a gain of the one or more cascaded drivers along the first transmission path for generating the predistorted signal.

In an embodiment, the processor may be configured to record the one or more inverse co-efficients of the one or more cascaded drivers in the LUT.

In an embodiment, the processor may be configured to facilitate the measurement of the predistorted signal of the one or more cascaded drivers.

In an embodiment, the processor may be configured to monitor an error based on a difference between the output signal of the PA and the RF input signal and re-compute the gain of the one or more cascaded drivers based on the error.

In an embodiment, the processor may be configured to modify the predistorted signal based on the re-computed gain of the one or more cascaded drivers and provide the modified predistorted signal to the PA.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example system architecture (100) for implementing a proposed system (102), in accordance with an embodiment of the present disclosure.

FIG. 2 illustrates an example block diagram (200) of a proposed system (102), in accordance with an embodiment of the present disclosure.

FIGS. 3A-3C illustrate example representations of amplitude modulation (300) with various configurations of a pre-driver, a driver, and a power amplifier versus the proposed system (102), in accordance with embodiments of the present disclosure.

FIGS. 4A-4C illustrate example representations of phase modulation (400) with various configurations of the pre-driver, the driver, and the power amplifier versus the proposed system (102), in accordance with embodiments of the present disclosure.

FIGS. 5A-5C illustrate example representations of a spectrum plot (500) with various configurations of the pre-driver, the driver, and the power amplifier versus the proposed system (102), in accordance with embodiments of the present disclosure.

FIG. 6 illustrates an example representation of a flow diagram of a method (600) of the proposed system (102), in accordance with an embodiment of the present disclosure.

FIG. 7 illustrates an example computer system (700) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A linear power amplifier in a transceiver preserves quality of an input signal and reduces the interference with other signals at the cost of efficiency. However, in a process to increase efficiency, the linearity is reduced. The present disclosure describes an efficient and linear pre-driver and Driver chain (PDDC) preceding a power amplifier that improves an overall efficiency and linearity of the transmitter. Typically, PDDC is operated in a linear region but that does not provide significant power saving. If the PDDC can be driven into mild/high non-linearity for improved efficiency, then the PDDC output when applied to the power amplifier, will result in increased output distortion. The proposed solution achieves significant power saving as the driver is operated at a saturated power and the power amplifier is operated in a back-off mode. The proposed solution enables the power amplifier to drive more power while at the same time increases a peak to average power ratio (PAPR) and linearity of the power amplifier.

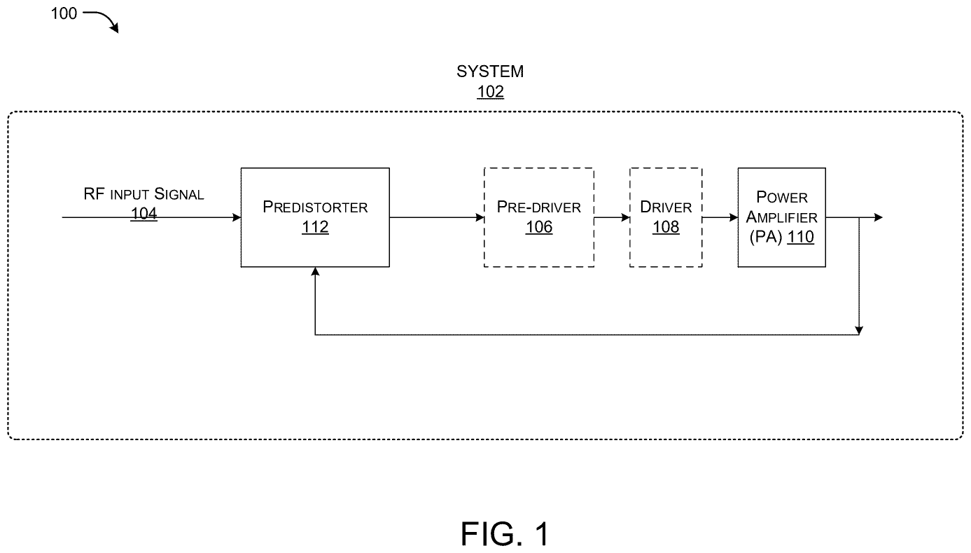

Various embodiments of the present disclosure will be explained in detail with reference to FIGS. 1-7.

FIG. 1 illustrates an example system architecture (100) for implementing a proposed system (102), in accordance with an embodiment of the present disclosure.

As illustrated in FIG. 1, in an embodiment, the system (102) may receive a Radio Frequency (RF) signal (104) where the RF input signal (104) may be processed in a transceiver of a base station. The RF input signal (104) may be provided to one or more cascaded drivers (106, 108) prefixed with a PA (110) for generating a predistorted signal to the PA (110). The one or more cascaded drivers may include a pre-driver (106) and a driver (108) prefixed to the PA (110). A predistorter (112) configured with the system (102) may change one or more inverse co-efficients associated with a gain of the PA (110) to facilitate a linearized power output through the PA (110).

In an embodiment, the system (102) may determine the predistorted signal associated with a coupled power output of the PA (110) along a first transmission path among one or more transmission paths based on the RF input signal (102) received by the transceiver. The system (102) may determine, an output signal associated with the coupled power output of the PA along a second transmission path among the one or more transmission paths, where the coupled power output may be based on the predistorted signal. The system (102) may monitor, the output signal associated with the PA (110). The system (102) may vary the predistorted signal to generate the power output through the PA (110).

In an embodiment, the system (102) may facilitate the measurement of the predistorted signal of the one or more cascaded drivers. Further, the system (102) may compute, the one or more inverse co-efficients associated with a gain of the PA (110), where the gain may be computed by the system (102) based on the output signal associated with the PA (110). Further, the system (102) may record the one or more inverse co-efficients associated with the gain in a Look-Up Table (LUT) of the system (102).

In an embodiment, the system (102) may compute an error based on a difference between the gain of the PA (110) and the RF input signal (104) using a Digital Pre-Distortion (DPD) technique and facilitate the modification of the predistorted signal.

In an embodiment, the system (102) may compute one or more inverse co-efficients of the one or more cascaded drivers (106, 108) to determine a gain of the one or more cascaded drivers (106, 108) along the first transmission path for generating the predistorted signal. The system (102) may record the one or more inverse co-efficients of the one or more cascaded drivers (106, 108) in the LUT.

In an embodiment, the system (102) may monitor an error based on a difference between the output signal of the PA (110) and the RF input signal (104) and re-compute the gain of the one or more cascaded drivers (106, 108) based on the error. Further, the system (102) may modify the predistorted signal based on the re-computed gain of the one or more cascaded drivers (106, 108) and provide the modified predistorted signal to the PA (110).

Although FIG. 1 shows exemplary components of the system architecture (100), in other embodiments, the system architecture (100) may include fewer components, different components, differently arranged components, or additional functional components than depicted in FIG. 1. Additionally, or alternatively, one or more components of the system architecture (100) may perform functions described as being performed by one or more other components of the system architecture (100).

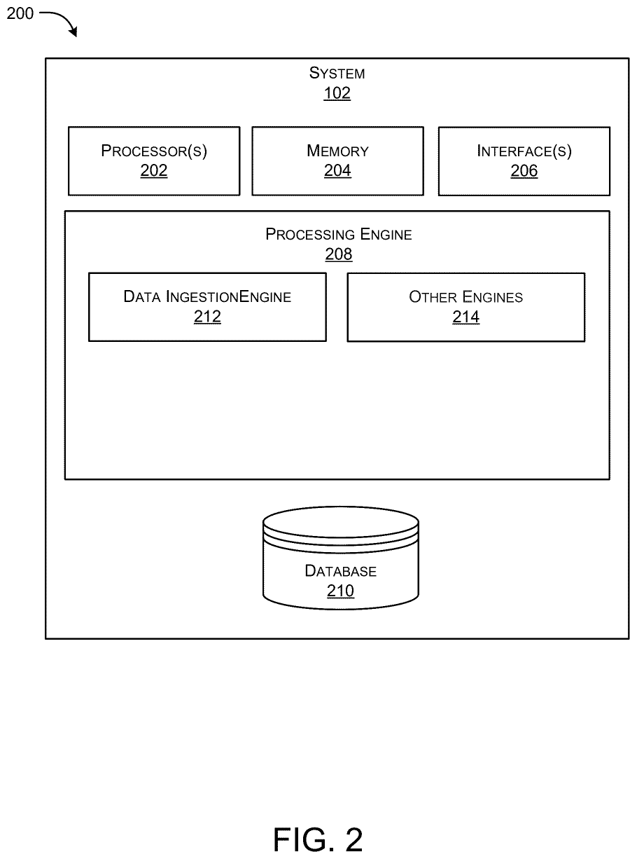

FIG. 2 illustrates an example block diagram (200) of a proposed system (102), in accordance with an embodiment of the present disclosure.

Referring to FIG. 2, the system (102) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (102). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (102) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (102). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (102) may comprise the machine-readable storage medium storing the instructions and the processing resource to execute the instructions, or the machine-readable storage medium may be separate but accessible to the system (102) and the processing resource. In other examples, the processing engine(s) (208) may be implemented by electronic circuitry.

In an embodiment, the processor (202) may receive an RF input signal (104) via the data ingestion engine (212). The processor (202) may store the RF input signal (104) in the database (210). The RF input signal (104) may be provided to one or more cascaded drivers (106, 108) prefixed with a PA (110) for generating a predistorted signal to the PA (110). The one or more cascaded drivers may include a pre-driver (106) and a driver (108) prefixed to the PA (110). A predistorter (112) configured with the processor (202) may change one or more inverse co-efficients associated with a gain of the PA (110) to facilitate a linearized power output through the PA (110).

In an embodiment, the processor (202) may determine the predistorted signal associated with a coupled power output of the PA (110) along a first transmission path among one or more transmission paths based on the RF input signal (102) received by the transceiver. The processor (202) may determine, an output signal associated with the coupled power output of the PA (110) along a second transmission path among the one or more transmission paths, where the coupled power output may be based on the predistorted signal. The processor (202) may monitor, the output signal associated with the PA (110). The processor (202) may vary the predistorted signal to generate the power output through the PA (110).

In an embodiment, the processor (202) may facilitate the measurement of the predistorted signal of the one or more cascaded drivers. Further, the processor (202) may compute the one or more inverse co-efficients associated with a gain of the PA (110), where the gain may be computed by the processor (202) based on the output signal associated with the PA (110). Further, the processor (202) may record the one or more inverse co-efficients associated with the gain in a Look-Up Table (LUT) in a memory (204) of the processor (202).

In an embodiment, the processor (202) may compute an error based on a difference between the gain of the PA (110) and the RF input signal (104) using a Digital Pre-Distortion (DPD) technique and facilitate the modification of the predistorted signal.

In an embodiment, the processor (202) may compute one or more inverse co-efficients of the one or more cascaded drivers (106, 108) to determine a gain of the one or more cascaded drivers (106, 108) along the first transmission path for generating the predistorted signal. The processor (202) may record the one or more inverse co-efficients of the one or more cascaded drivers (106, 108) in the LUT.

In an embodiment, the processor (202) may monitor an error based on a difference between the output signal of the PA (110) and the RF input signal (104) and re-compute the gain of the one or more cascaded drivers (106, 108) based on the error. Further, the processor (202) may modify the predistorted signal based on the re-computed gain of the one or more cascaded drivers (106, 108) and provide the modified predistorted signal to the PA (110).

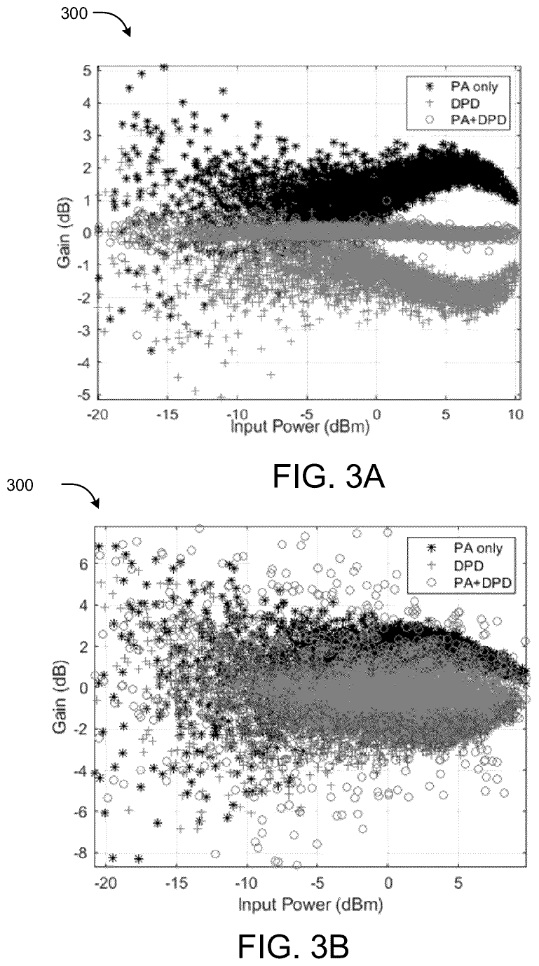

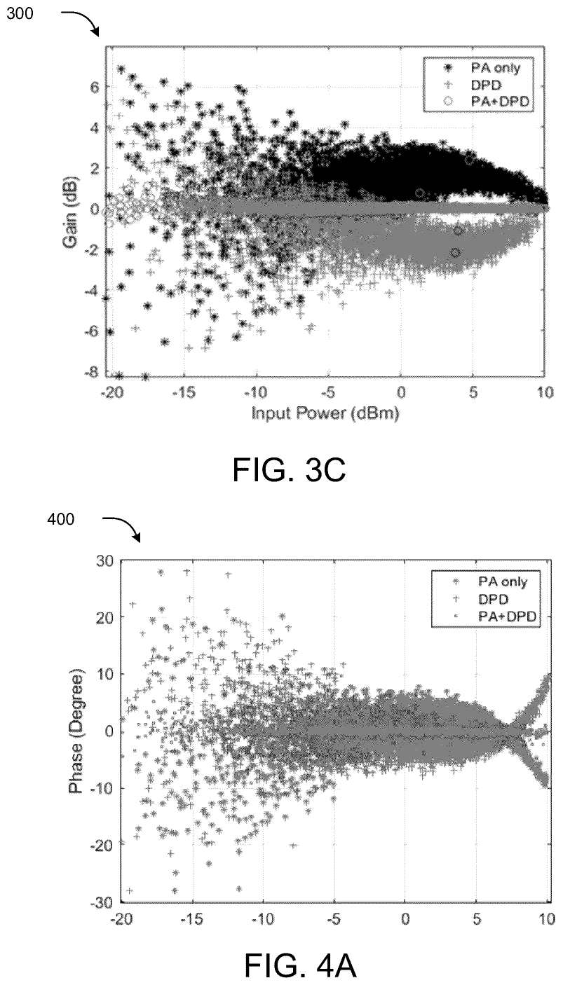

FIGS. 3A-3C illustrate example representations of amplitude modulation to amplitude modulation (AM-AM) (300) with various configurations of a pre-driver, a driver, and a power amplifier versus the proposed system (102), in accordance with embodiments of the present disclosure.

In an embodiment, to validate a proposed method implemented by the system (102), an FDD_100 MHz_30 Khz_TM1p1 signal at a sampling rate of 491.52 mega samples per second (MSPS) may be used; other signal can also be used for validation. This method may be applicable for all fourth generation/fifth generation (4G/5G) signals and with applicable sampling rates. The system (102) may include a memory polynomial model for processing the baseband signal received by the transmitter. FIG. 3C illustrates the AM-AM plot (Gain vs input power) using the application of proposed method/system (102) where one can see the gain compression is minimised and it becomes linear.

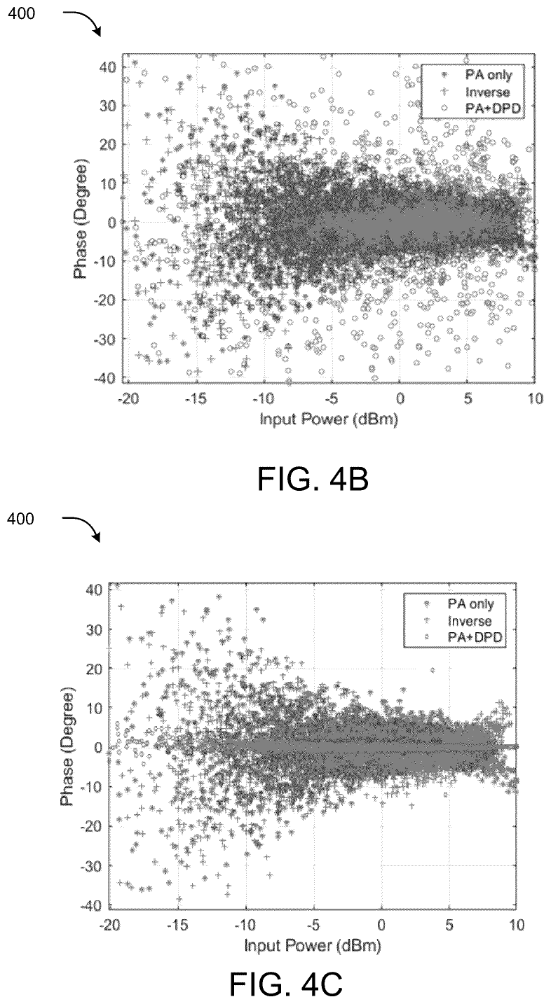

FIGS. 4A-4C illustrate example representations of amplitude modulation to phase modulation (AM-PM) (400) with various configurations of the pre-driver, the driver, and the power amplifier versus the proposed system (102), in accordance with embodiments of the present disclosure.

As illustrated in FIG. 4C, in an embodiment, amplitude modulation to phase modulation (AM-PM) with application of proposed method/system (102) where one can see the phase scattering is minimised and it becomes linear.

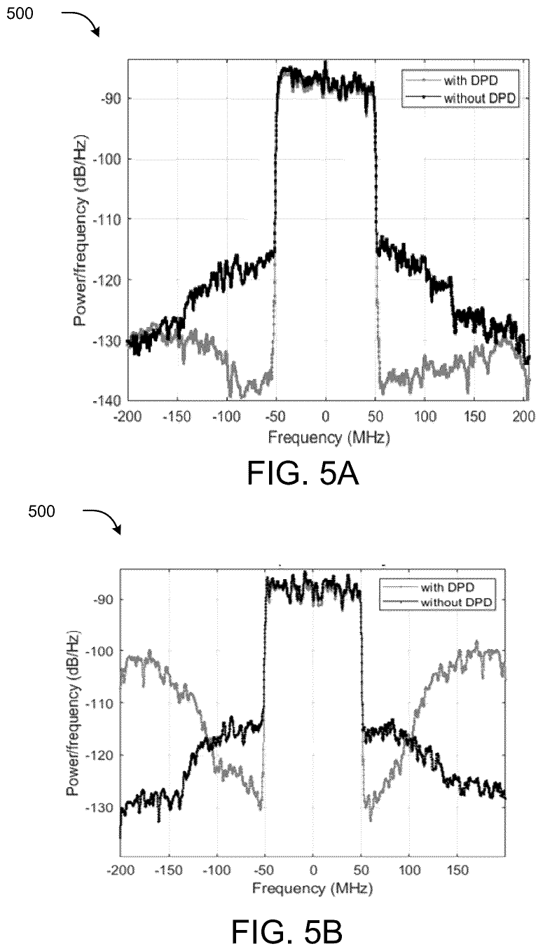

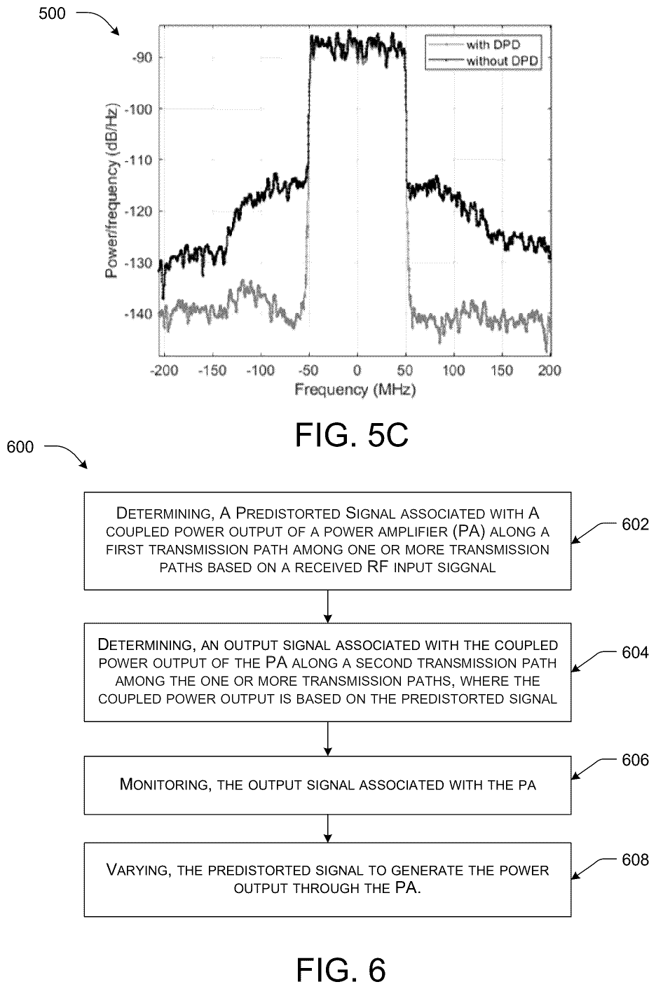

FIGS. 5A-5C illustrate example representations of a spectrum plot (500) with various configurations of the pre-driver, the driver, and the power amplifier versus the proposed system (102), in accordance with embodiments of the present disclosure.

As illustrated in FIG. 5C, in an embodiment, the spectrum plot generated by the system (102) is shown. It shows the PA output distortions has been reduced and it becomes distortion free (adjacent channel leakage ratio (ACLR) is reduced to −53.4/−53.1 dBc approximately) with the application of the proposed method/system

FIG. 6 illustrates an example representation of a flow diagram of a method (600) of the proposed system (102), in accordance with an embodiment of the present disclosure.

In an embodiment, the flow diagram may include the following steps.

At step 602: The method may include determining, by a system (102), a predistorted signal associated with a coupled power output of a PA (104) along a first transmission path among one or more transmission paths based on a received RF input signal (104).

At step 604: The method may include determining, an output signal associated with a coupled power output of the PA (112) along a second transmission path among the one or more transmission paths, where the coupled power output is based on the predistorted signal.

At step 606: The method may include monitoring, the output signal associated with the PA (112).

At step 608: The method may include varying the predistorted signal to generate the power output through the PA (110).

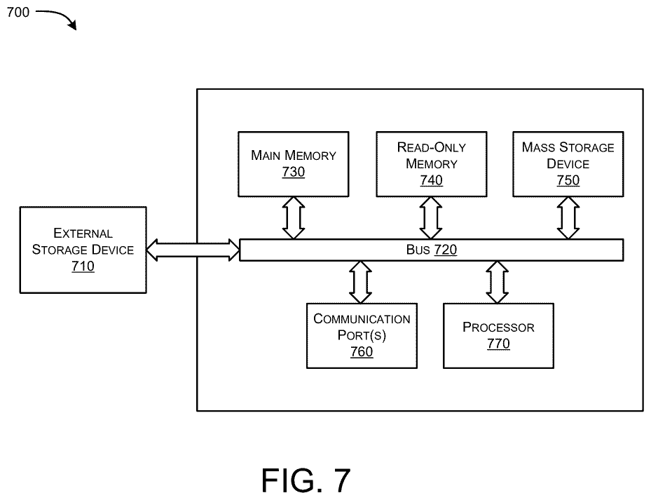

FIG. 7 illustrates an exemplary computer system (700) in which or with which embodiments of the present disclosure may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces). In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that linearizes a predriver and a driver chain (PDDC) using digital-predistortion (DPD) technique to generate a power output from a power amplifier (PA) without any distortions.

The present disclosure provides a system and a method that drives the PDDC into mild/high non-linearity for generating improved power efficiency through the PA.

The present disclosure provides a system and a method that drives more power through the power amplifier while increasing a peak to average power ration (PAPR) of the power amplifier.

We claim:

1. A method for generating a power output in a transceiver, the method comprising:
determining, a predistorted signal associated with a coupled power output of a power amplifier along a first transmission path among one or more transmission paths based on a received RF input signal;
determining, an output signal associated with the coupled power output of the PA along a second transmission path among the one or more transmission paths, wherein the coupled power output is based on the predistorted signal;
monitoring, the output signal associated with the PA; and
varying, the predistorted signal to generate the power output through the PA.

2. The method as claimed in claim 1, wherein the PA comprises one or more cascaded drivers prefixed with the PA that generates the predistorted signal.

3. The method as claimed in claim 1, comprising computing, one or more inverse co-efficients associated with a gain of the PA, wherein the gain is computed based on the output signal associated with the PA.

4. The method as claimed in claim 3, comprising recording, the one or more inverse co-efficients associated with the gain in a Look-Up Table.

5. The method as claimed in claim 3, comprising computing, an error based on a difference between the gain of the PA and the RF input signal and facilitating the modification of the predistorted signal.

6. The method as claimed in claim 2, comprising computing, one or more inverse co-efficients of the one or more cascaded drivers to determine a gain of the one or more cascaded drivers along the first transmission path for generating the predistorted signal.

7. The method as claimed in claim 6, comprising recording, the one or more inverse co-efficients of the one or more cascaded drivers in the LUT.

8. The method as claimed in claim 2, comprising facilitating, the measurement of the predistorted signal of the one or more cascaded drivers.

9. The method as claimed in claim 1, comprising facilitating, the measurement of the output signal of the PA along the second transmission path.

10. The method as claimed in claim 6, comprising continuously monitoring, an error based on a difference between the output signal of the PA and the RF input signal and re-computing, the gain of the one or more cascaded drivers based on the error.

11. The method as claimed in claim 10, comprising modifying, the predistorted signal based on the re-computed gain of the one or more cascaded drivers and providing the modified predistorted signal to the PA.

12. A system for generating a power output in a transceiver, the system comprising:
a processor communicatively coupled to a transceiver of the system;
a memory operatively coupled with the processor, wherein said memory stores instructions which, when executed by the processor, cause the processor to:
determine a predistorted signal associated with a coupled power output of a power amplifier along a first transmission path among one or more transmission paths based on an RF input signal received by the transceiver;
determine, an output signal associated with the coupled power output of the PA along a second transmission path among the one or more transmission paths, wherein the coupled power output is based on the predistorted signal;
monitor, the output signal associated with the PA; and
vary the predistorted signal to generate the power output through the PA.

13. The system as claimed in claim 12, wherein the PA comprises one or more cascaded drivers prefixed with the PA that generates the predistorted signal.

14. The system as claimed in claim 12, wherein the processor is configured to compute, one or more inverse co-efficients associated with a gain of the PA, wherein the gain is computed by the processor based on the output signal associated with the PA.

15. The system as claimed in claim 12, wherein the processor is configured to record the one or more inverse co-efficients associated with the gain in a Look-Up Table of the memory.

16. The system as claimed in claim 12, wherein the processor is configured to compute an error based on a difference between the gain of the PA and the RF input signal using a Digital Pre-Distortion technique and facilitate the modification of the predistorted signal.

17. The system as claimed in claim 12, wherein the processor is configured to compute one or more inverse co-efficients of the one or more cascaded drivers to determine a gain of the one or more cascaded drivers along the first transmission path for generating the predistorted signal.

18. The system as claimed in claim 17, wherein the processor is configured to record the one or more inverse co-efficients of the one or more cascaded drivers in the LUT.

19. The system as claimed in claim 12, wherein the processor is configured to facilitate the measurement of the predistorted signal of the one or more cascaded drivers.

20. The system as claimed in claim 12, wherein the processor is configured to monitor an error based on a difference between the output signal of the PA and the RF input signal and re-compute the gain of the one or more cascaded drivers based on the error.

21. The system as claimed in claim 20, wherein the processor is configured to modify the predistorted signal based on the re-computed gain of the one or more cascaded drivers and provide the modified predistorted signal to the PA.
